(19) United States
(12) Patent Application Publication
(10) Pub. No.: US 2026/0179525 A1
(43) Pub. Date: Jun. 25, 2026

(54) TIMING CONTROLLER STORING LOG DATA AND DISPLAY DEVICE INCLUDING THE SAME, AND METHOD OF OPERATING TIMING CONTROLLER

(71) Applicant: Samsung Electronics Co., Ltd., Suwon-si (KR)

(72) Inventors: Jung Ho Kim, Suwon-si (KR); San Ha Yoon, Suwon-si (KR); Young Min Shin, Suwon-si (KR); Sang Min Shim, Suwon-si (KR)

(21) Appl. No.: 19/427,178

(22) Filed: Dec. 19, 2025

(30) Foreign Application Priority Data
Dec. 23, 2024 (KR) 10-2024-0193705

(51) Int. Cl. G09G 3/20

(52) U.S. Cl. CPC G09G 3/2092; G09G 2310/08; G09G 2370/047; G09G 2370/12

(57) ABSTRACT

A timing controller includes a communication interface circuit, a timing circuit, and an analyzing circuit. The communication interface circuit is configured to receive a first channel signal and a second channel signal from a host device through a first channel and a second channel, respectively. The timing circuit is configured to generate display data based on the first channel signal and the second channel signal, and transmit the display data to a source driver. The analyzing circuit is configured to synchronize the first channel signal and the second channel signal, extract a portion of the synchronized first channel signal and second channel signal, and store the extracted portion as log data in an internal memory device.

### CROSS-REFERENCE TO RELATED APPLICATION(S)

This U.S. non-provisional application claims priority under 35 USC § 119 to Korean Patent Application No. 10-2024-0193705, filed on December 23, 2024, in the Korean Intellectual Property Office, the disclosure of which is herein incorporated by reference in its entirety.

### BACKGROUND

The present disclosure relates to a display driving integrated circuit and, more particularly, to a timing controller storing log data, a display device including the timing controller, and a method of operating the timing controller.

A timing controller may communicate with a host and various display interfaces.

A timing controller (TCON) receives image data and control signals from a host. The timing controller converts the received data into a format available in a display panel of a flat panel display device such as a liquid crystal display (LCD) or an organic light emitting diode (OLED), and provides the converted data to a display driving integrated circuit (DDI). The timing controller manages synchronization signals for the operation of the display panel.

It may be difficult to analyze display scenarios, as vendors of hosts and timing controllers often differ in their implementations. Accordingly, there is a need for advanced technology to analyze display scenarios under diverse environments.

### SUMMARY

One or more embodiments provide a technology for stably analyzing a display scenario of a host.

One or more embodiments provide a technology for stably analyzing a display scenario of a host when the host transmits signals through a plurality of asynchronous channels.

According to one or more embodiment, a timing controller includes a communication interface circuit configured to receive a first channel signal and a second channel signal from a host device through a first channel and a second channel, respectively, a timing circuit configured to generate display data based on the first channel signal and the second channel signal and transmit the display data to a source driver, and an analyzing circuit configured to synchronize the first channel signal and the second channel signal, extract a portion of the synchronized first channel signal and second channel signal, and store the extracted portion as log data in an internal memory device.

According to one or more embodiments, a display device includes a timing controller configured to receive a first channel signal and a second channel signal from a host device through a first channel and a second channel, respectively, generate display data based on the first channel signal and the second channel signal, and transmit the display data to a display driving integrated circuit, and a display driving integrated circuit configured to drive a display panel based on the display data. The timing controller may include an analyzing circuit configured to synchronize the first channel signal and the second channel signal, extract a portion of the synchronized first channel signal and second channel signal, and store the extracted portion as log data in an internal memory device.

According to one or more embodiments, a method of operating a timing controller includes receiving a first channel signal and a second channel signal from a host device, synchronizing the first channel signal and the second channel signal, comparing sampling timings of the first channel signal and the second channel signal, extracting first log information and second log information from the synchronized first channel signal and second channel signal, respectively, generating a first log entry and a second log entry by encoding the first log information and the second log information, and storing the first log entry and the second log entry in an internal memory device.

### BRIEF DESCRIPTION OF DRAWINGS

FIG. 1 is a block diagram illustrating a display system according to one or more embodiments.

FIG. 2 is a block diagram illustrating a method of analyzing optionally alternative display signals.

FIG. 3 is a block diagram illustrating a display device including a timing controller according to one or more embodiments.

FIG. 4 is a flowchart illustrating an operation method of a timing controller according to one or more embodiments.

FIG. 5 is a block diagram illustrating the configuration of an analyzing circuit of a timing controller according to one or more embodiments.

FIG. 6 is a diagram illustrating a structure of a log entry according to one or more embodiments.

FIG. 7 is a diagram illustrating a structure of a flag signal of a log entry according to one or more embodiments.

FIG. 8 is a block diagram illustrating a display system based on an eDP interface according to one or more embodiments.

FIG. 9 is a diagram illustrating log data of a first channel signal based on an eDP interface according to one or more embodiments.

FIG. 10 is a diagram illustrating a structure of a log entry for a first channel signal based on an eDP interface according to one or more embodiments.

FIG. 11 is a diagram illustrating a structure of a log entry for a second channel signal based on an eDP interface according to one or more embodiments.

FIG. 12 is a diagram illustrating a memory device storing log data according to one or more embodiments.

FIGS. 13 to 15 are diagrams illustrating methods of operating a memory device according to one or more embodiments.

FIG. 16 is a block diagram illustrating a display system based on an HDMI interface according to one or more embodiments.

FIG. 17 is a block diagram illustrating a display system based on a MIPI interface according to one or more embodiments.

### DETAILED DESCRIPTION

Hereinafter, example embodiments will be described with reference to the accompanying drawings.

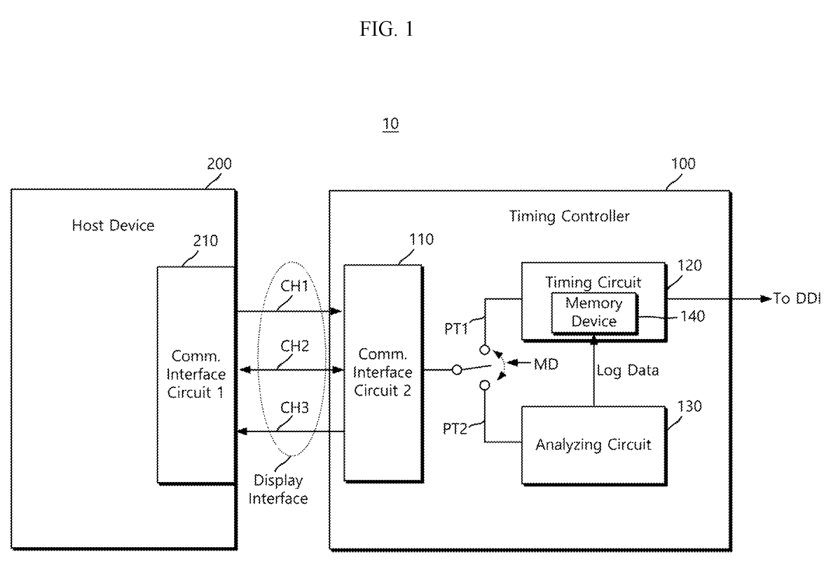

FIG. 1 is a block diagram illustrating a display system 10 according to one or more embodiments.

Referring to FIG. 1, the display system 10 may include a host device 200 and a timing controller 100.

In the display system 10 according to one or more embodiments, the timing controller 100 may store at least a portion of channel signals received from the host device 200 through a plurality of channels as log data. The plurality of channels may be asynchronous channels, and the channel signals received from the host device 200 through the plurality of channels may be asynchronous channel signals.

The display system 10 may be implemented as an electronic device that may use a display interface.

For example, the electronic device may be implemented as a laptop computer, a tablet computer, a smartphone, a personal digital assistant (PDA), an enterprise digital assistant (EDA), a digital still camera, a digital video camera, a portable multimedia player (PMP), a personal navigation device (PND), a mobile internet device (MID), or a wearable computer.

The host device 200 may operate as a source device of the display system 10, and the timing controller 100 may operate as a sink device of the display system 10.

The host device 200 may be implemented as a graphics processing unit (GPU), a system-on-chip (SoC), or an application processor (AP).

The host device 200 may control the operation of the timing controller 100. For example, the host device 200 may transmit display signals to the timing controller 100 using a display interface.

The host device 200 may communicate with the timing controller 100 through various display interfaces. For example, the host device 200 may transmit and receive display signals to and from the timing controller 100 through display interfaces such as embedded DisplayPort (eDP), DisplayPort (DP), Mobile Industry Processor Interface (MIPI), or High-Definition Multimedia Interface (HDMI). Standard documents for implementing display interfaces such as eDP, DP, MIPI, or HDMI are incorporated herein by reference.

The host device 200 may communicate with a second communication interface circuit 110 of the timing controller 100 through a first communication interface circuit 210.

The first communication interface circuit 210 of the host device 200 and the second communication interface circuit 110 of the timing controller 100 may each include a physical layer PHY and a link layer for implementing a display interface.

For example, when the host device 200 and the timing controller 100 communicate via the MIPI interface, the first communication interface circuit 210 and the second communication interface circuit 110, acting as a physical layer, may include driving circuits to transmit display signals through a clock lane and a data lane.

For example, when the host device 200 and the timing controller 100 communicate via an eDP interface, the first communication interface circuit 210 and the second communication interface circuit 110, acting as a physical layer, may include driving circuits to transmit display signals through a plurality of link lanes such as a main link ML, an auxiliary channel AUX, and a hot plug detect HPD.

In addition, the first communication interface circuit 210 and the second communication interface circuit 110 may include physical and logical blocks supporting a physical layer and a link layer for transmitting display signals using various display interfaces, and embodiments are not limited to a display system using a specific display interface.

The timing controller 100 may be a portion of a display device, and include a timing circuit 120.

The timing circuit 120 may serve to control a display driving integrated circuit DDI. For example, the timing circuit 120 may receive display signals from the host device 200 through a plurality of channels. Referring to FIG. 1, the display signals may include a first channel signal and a second channel signal received through a first channel CH1 and a second channel CH2, respectively. The first channel signal and the second channel signal may be signals that are not be synchronized with each other. For example, the first channel signal and the second channel signal may be asynchronous with respect to each other.

The timing circuit 120 may generate control signals for controlling the display driving integrated circuit DDI based on the display signals. Additionally, the timing controller 100 may convert the format of image data of the display signals and transmit the converted image data to the display driving circuit DDI. For example, the display data may be transmitted to a source driver of the display driving integrated circuit DDI.

The timing controller 100 according to one or more embodiments may include an analyzing circuit 130.

The analyzing circuit 130 may synchronize at least a portion of the plurality of channel signals received from the host device 200, extract a portion of the synchronized channel signals, and store the extracted channel signals as log data in an internal memory device.

FIG. 1 illustrates an example in which the host device 200 and the timing controller 100 communicate with each other through three channels CH1, CH2, and CH3. FIG. 1 illustrates an example in which the first channel CH1 is a channel for unidirectionally receiving display signals from the host device 200, the second channel CH2 is a channel for bidirectionally transmitting and receiving display signals with the host device 200, and the third channel CH3 is a channel for unidirectionally transmitting display signals from the timing controller 100.

For example, referring to FIG. 1, the analyzing circuit 130 may extract a portion of the first channel signal and the second channel signal received through the first channel CH1 and the second channel CH2, respectively, from the host device 200, and store the extracted signals as log data in an internal memory device. In one or more embodiments, the internal memory device may be a memory device 140 of the timing circuit 120. For example, the memory device 140 may be a static random access memory (SRAM) that temporarily stores data of logic circuits constituting a pixel pipeline of the timing circuit 120.

The analyzing circuit 130 may extract necessary signals from the plurality of channel signals received from the host device 200 and store the extracted signals as log data to analyze a display scenario of the host device 200. The display scenario may refer to the purpose, or the like, for which the host device 200 transmits display signals to the display device. For example, the display scenario may include various utilization forms of display signals, such as transmitting a command to change brightness while displaying image data on the display device.

The analyzing circuit 130 may store the log data, extracted from the necessary signals of the plurality of channel signals received from the host device 200, in an internal memory device, and an external device of the timing controller 100 may analyze the stored log data. Thus, the external device may analyze the display scenario of the host device 200 based on the channel signals received from the host device 200 in an actual display environment. The external device may analyze whether the timing circuit 120 operates appropriately, based on the display scenario.

In one or more embodiments, the timing controller 100 may include a first internal signal path PT1 between the second communication interface circuit 110 and the timing circuit 120 and a second internal signal path PT2 between the second communication interface circuit 110 and the analyzing circuit 130.

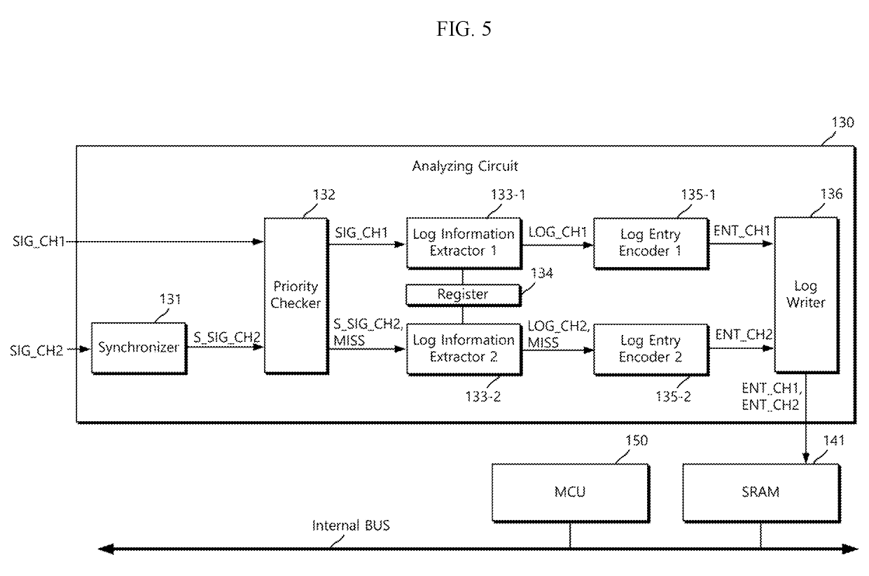

In one or more embodiments, either the first internal signal path PT1 or the second internal signal path PT2 may be selectively activated based on a mode signal MD. For example, the mode signal MD may be provided from a selection circuit based on an analysis request from an external device. For example, the selection circuit may be a micro control unit (MCU) 150 of FIG. 5. Accordingly, the analyzing circuit 130 may operate only in analysis mode and fully use the memory device 140 of the timing circuit 120.

In one or more embodiments, unlike the illustration of FIG. 1, the second internal signal path PT2 may be additionally activated based on the mode signal MD along with the first internal signal path PT1. For example, in a normal mode, channel signals may be transmitted to the timing circuit 120 through the first internal signal path PT1 and then to the display driving circuit DDI. In an analysis mode, channel signals may be transmitted not only to the timing circuit 120 through the first internal signal path PT1 but also to the analyzing circuit 130 through the second internal signal path PT2. Accordingly, the timing circuit 120 may operate in both the normal mode and the analysis mode, and the external device may analyze the log data along with an actual display results of the display device. As a result, the display scenario of the host device 200 may be comprehensively analyzed.

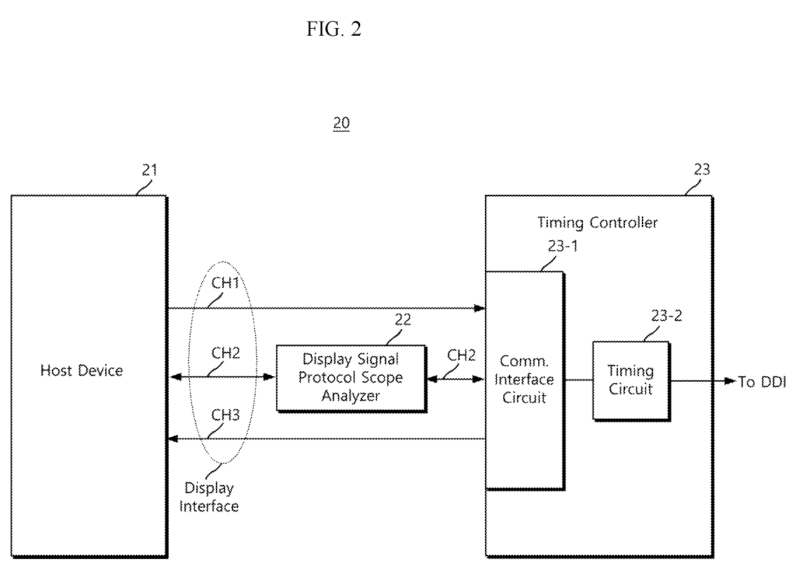

FIG. 2 is a block diagram illustrating a method of analyzing optionally alternative display signals.

A host device 21 of a display system 20 transmits image data and control signals to a timing controller 23 of the display system 20 based on various scenarios, but it may be difficult for an analyzing device to analyze the signals received from the host device 21.

Referring to FIG. 2, optionally alternative analyzing equipment may be a display signal protocol scope analyzer 22 disposed in a channel signal transmission path between the host device 21 and the timing controller 23.

For example, the display signal protocol scope analyzer 22 may be disposed in at least one channel signal transmission path, among a plurality of channel signal transmission paths between the host device 21 and the timing controller 23, and may capture a portion of the channel signal transmitted from the host device 21 to the timing controller 23.

However, signals that the display signal protocol scope analyzer 22 can capture are limited to specific types, such as indication signals.

In addition, the display signal protocol scope analyzer 22 has vulnerability in analyzing high-speed display interfaces and small-to-medium-sized display devices. For example, as the display interface supports higher-speed signal transmission, the channel environment may deteriorate and signal attenuation may become more severe. Therefore, the display signal protocol scope analyzer 22 disposed in the channel signal transmission path may be affected by the transmission environment during the analysis of channel signals transmitted from the host device 21.

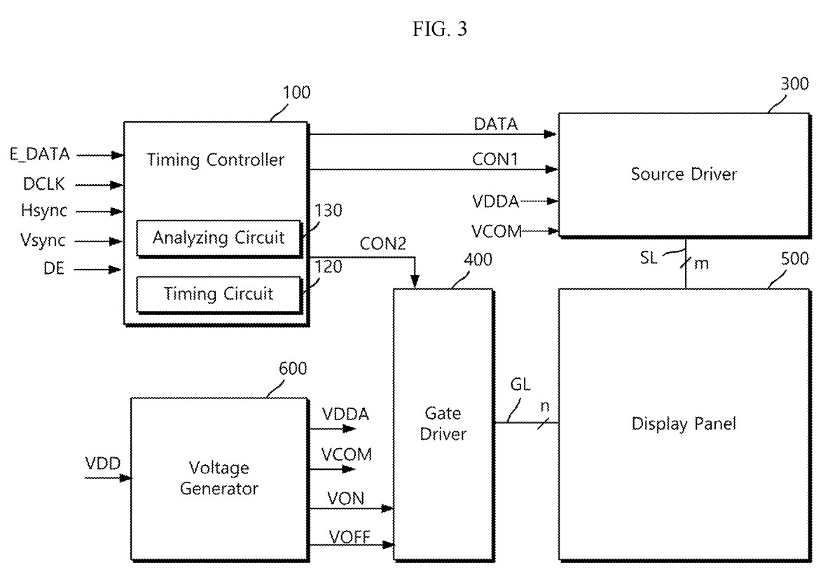

FIG. 3 is a block diagram illustrating a display device including a timing controller 100 according to one or more embodiments.

Referring to FIG. 3, the display device may include a timing controller 100, a source driver 300, a gate driver 400, a display panel 500, and a voltage generator 600.

The timing controller 100 may include an analyzing circuit 130 and a timing circuit 120. The timing controller 100, the analyzing circuit 130 and the timing circuit 120 of FIG. 3 may correspond to the timing controller 100, the analyzing circuit 130 and the timing circuit 120 of FIG. 1, respectively.

The source driver 300 and the gate driver 400 may be implemented as the display driving integrated circuit DDI.

The display driving integrated circuit DDI for driving the display panel 500 may include the source driver 300 driving a plurality of source lines SL of the display panel 500, the gate driver 400 driving a plurality of gate lines GL of the display panel 500, the timing controller 100 outputting timing signals CON1 and CON2 and data signals (or data) DATA, and the voltage generator 600 outputting various voltages VON, VOFF, VDDA, and VCOM required to drive the display device.

The display panel 500 may include the plurality of gate lines GL, the plurality of source lines SL arranged in a direction intersecting the plurality of gate lines, and pixels arranged at intersections of the plurality of gate lines GL and the plurality of source lines SL.

The source driver 300 may include one or more individual source drivers. For example, the source driver 300 may include a plurality of individual source drivers, and one or more source lines may be driven by each of the individual source drivers depending on a size of the display panel 500. Similarly, the gate driver 400 may include one or more individual gate drivers, and one or more gate lines may be driven by each of the individual gate drivers.

The timing controller 100 may receive external data E_DATA, a horizontal synchronization signal Hsync, a vertical synchronization signal Vsync, a clock signal DCLK, and a data enable signal DE from an external device (for example, the host device 200 of FIG. 1).

The timing circuit 120 may generate data DATA by converting the protocol of the external data E_DATA for interfacing with the source driver 300 and transmit the data DATA to the source driver 300.

The timing circuit 120 may output control signals for controlling the timing of the source driver 300 and the gate driver 400, and transmit one or more first control signals CON1 to the source driver 300 and one or more second control signals CON2 to the gate driver 400.

The voltage generator 600 may receive a power supply voltage VDD from an external source and generate various voltages required for the operation of the display device. For example, the voltage generator 600 may output a gate-on voltage VON and a gate-off voltage VOFF to the gate driver 400 and an analog power supply voltage VDDA and a common voltage VCOM to the source driver 300.

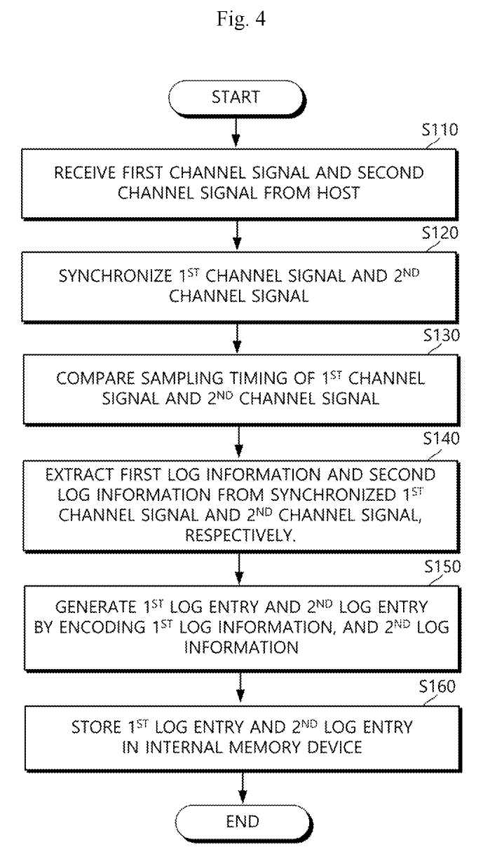

FIG. 4 is a flowchart illustrating a method of operating a timing controller according to one or more embodiments. The method of FIG. 4 may be performed by the timing controller 100 of FIG. 1. The method of operating the timing controller 100 will be described with reference to FIG. 4.

In operation S110, the timing controller 100 may receive a first channel signal and a second channel signal from the host device 200. The first channel signal and the second channel signal may be asynchronous with respect to each other. The first channel signal may be based on a first clock signal, and the second channel signal may be based on a second clock signal. A clock frequency of the first clock signal may be different from a clock frequency of the second clock signal. For example, the clock frequency of the first clock signal may be higher than the clock frequency of the second clock signal.

In operation S120, the timing controller 100 may synchronize the first channel signal and the second channel signal with each other. For example, the second channel signal may be synchronized to the clock frequency of the first clock signal.

In operation S130, the timing controller 100 may compare sampling timings of the synchronized first channel signal and second channel signal.

For example, the timing controller 100 may generate an indication signal based on a result of comparing the sampling timings of the first channel signal and the second channel signal. In one or more embodiments, when log data is stored, the timing controller 100 may prioritize and store either a first log entry based on the first channel signal or a second log entry based on the second channel signal.

In operation S140, the timing controller 100 may extract first log information and second log information from the synchronized first channel signal and second channel signal, respectively.

In one or more embodiments, portions to be extracted as first log information and/or second log information from the first channel signal and the second channel signal may be preconfigured in a register.

In operation S150, the timing controller 100 may generate a first log entry and a second log entry by encoding the first log information and the second log information, respectively. In one or more embodiments, the timing controller 100 may include the indication signal in either the first log entry or the second log entry.

In operation S160, the timing controller 100 may store the first log entry and the second log entry in an internal memory device. In one or more embodiments, the timing controller 100 may store either the first log entry or the second log entry in the internal memory device first, followed by the other, based on the indication signal.

FIG. 5 is a block diagram illustrating the configuration of an analyzing circuit 130 of a timing controller according to one or more embodiments. The analyzing circuit 130 of FIG. 5 may correspond to the analyzing circuit 130 of FIG. 1. The analyzing circuit 130 will be described with reference to FIG. 5.

Referring to FIG. 5, the analyzing circuit 130 may include a synchronizer 131, a priority checker 132, log information extractors 133-1 and 133-2, a register 134, log entry encoders 135-1 and 135-2, and a log writer 136.

The analyzing circuit 130 may receive a first channel signal SIG_CH1 and a second channel signal SIG_CH2 from the host device 200 of FIG. 1. The first channel signal SIG_CH1 and the second channel signal SIG_CH2 may be asynchronous with respect to each other.

For example, the first clock signal of the first channel signal SIG_CH1 may be received from the host device 200 of FIG. 1 and the first clock signal may be recovered from the first channel signal SIG_CH1 using a clock and data recovery (CDR) circuit. The second channel signal SIG_CH2 may be received based on a second clock signal different from the first clock signal. In one or more embodiments, the second clock signal may be based on an internal clock signal generated within the timing controller 100 of FIG. 1.

The synchronizer 131 may synchronize the second channel signal SIG_CH2 to the first channel signal SIG_CH1. For example, the second clock signal, on which the second channel signal SIG_CH2 is based, may be synchronized to the first clock signal, on which the first channel signal SIG_CH1 is based.

The priority checker 132 may compare the sampling timings of the first channel signal SIG_CH1 and the second channel signal SIG_CH2.

For example, the priority checker 132 may determine whether the sampling timing of the first channel signal SIG_CH1 is the same as the sampling timing of the second channel signal SIG_CH2, based on the first clock signal. The priority checker 132 may check whether the first channel signal SIG_CH1 and the second channel signal SIG_CH2 change at the same clock edge (a rising edge or a falling edge) of the first clock signal.

The priority checker 132 may generate a comparison result of the sampling timings of the first channel signal SIG_CH1 and the second channel signal SIG_CH2 as an indication signal MISS. For example, when the sampling timings of the first channel signal SIG_CH1 and the second channel signal SIG_CH2 are the same, the priority checker 132 may generate an indication signal MISS having a bit value of '1.' Conversely, when the sampling timings of the first channel signal SIG_CH1 and the second channel signal SIG_CH2 are different from each other, the priority checker 132 may generate an indication signal MISS having a bit value of '0.'

The priority checker 132 may transmit the first channel signal SIG_CH1 to the first log information extractor 133-1 and transmit the synchronized second channel signal S_SIG_CH2 and the indication signal MISS to the second log information extractor 133-2.

The first log information extractor 133-1 and the second log information extractor 133-2 may respectively extract log information from the first channel signal SIG_CH1 and the synchronized second channel signal S_SIG_CH2, and may output first log information LOG_CH1 and second log information LOG_CH2, respectively.

In one or more embodiments, at least one of the first log information extractor 133-1 and the second log information extractor 133-2 may extract log information from the first channel signal SIG_CH1 and the synchronized second channel signal S_SIG_CH2 based on reference information pre-stored in the register 134. For example, the register 134 may pre-store the location or items of log information to be extracted from the first channel signal SIG_CH1 and/or the synchronized second channel signal S_SIG_CH2. At least one of the first log information extractor 133-1 and the second log information extractor 133-2 may extract log information from the first channel signal SIG_CH1 and the synchronized second channel signal S_SIG_CH2 based on the location or items of log information stored in the register 134.

The second log information extractor 133-2 may output the indication signal MISS received along with the second log information LOG_CH2.

The first log entry encoder 135-1 and the second log entry encoder 135-2 may generate a first log entry ENT_CH1 and a second log entry ENT_CH2, respectively, based on the first log information LOG_CH1, the second log information LOG_CH2, and the indication signal MISS.

In one or more embodiments, the second log entry encoder 135-2 may generate a portion of the bit signals of the second log entry ENT_CH2 using the indication signal MISS.

The first log entry ENT_CH1 and the second log entry ENT_CH2 may each include a flag signal and a data signal. A method of encoding log entries will be described in detail below.

The log writer 136 may store the first log entry ENT_CH1 and the second log entry ENT_CH2 in an internal memory device. For example, the log writer 136 may store the first log entry ENT_CH1 and the second log entry ENT_CH2 in an SRAM 141. In one or more embodiments, the SRAM 141 may be the memory device 140 that temporarily stores data of the internal logic circuits of the timing circuit 120 of FIG. 1.

In one or more embodiments, the log writer 136 may store the first log entry ENT_CH1 in the internal memory device and then store the second log entry ENT_CH2 in the internal memory device.

For example, when the sampling timings of the first channel signal SIG_CH1 and the second channel signal SIG_CH2 are the same, the log writer 136 may store the first log entry ENT_CH1 in the internal memory device and then store the second log entry ENT_CH2 in the internal memory device. An analyzing device may determine that the second log entry ENT_CH2 corresponds to the first log entry ENT_CH1, based on the bit information of the second log entry ENT_CH2 corresponding to the indication signal MISS. For example, the second channel signal SIG_CH2 may be determined to be related to the first channel signal SIG_CH1. Accordingly, the analyzing device may analyze the display scenario of the host device 200 of FIG. 1 using the first log entry ENT_CH1 and the second log entry ENT_CH2 together.

The analyzing device may request the MCU 150 to read the log entries. The MCU 150 may read the log entries stored in the internal memory device (for example, the SRAM 141) via an internal bus. The MCU 150 may transmit the log entries to the analyzing device through an external input/output interface.

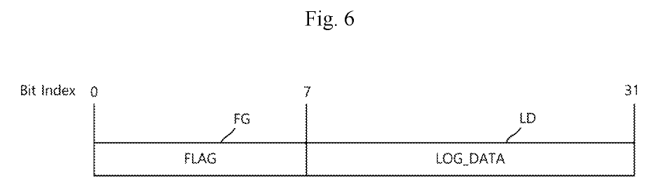

FIG. 6 is a diagram illustrating the structure of a log entry according to one or more embodiments. The log entry encoders 135-1 and 135-2 of FIG. 5 may generate log entries based on the first log information LOG_CH1, the second log information LOG_CH2, and the indication signal MISS.

The analyzing circuit 130 of FIG. 1 may generate a log entry based on each of the first channel signal and the second channel signal. For example, the analyzing circuit 130 may generate a plurality of log entries based on a first channel signal corresponding to a single one frame. Additionally, a log entry may be generated each time a second channel signal is received.

The log entry may include a flag signal FG and a log data signal LD.

FIG. 6 illustrates an example in which a log entry has 32 bits. In the example of FIG. 6, the flag signal FG may be a bit signal of 8 bits and the log data signal LD may be a bit signal of 24 bits.

According one or more embodiments, a log entry may include fewer or more than 32 bits. In such a case, the flag signal FG and the log data signal LD may include a different number of bits than those illustrated in FIG. 6.

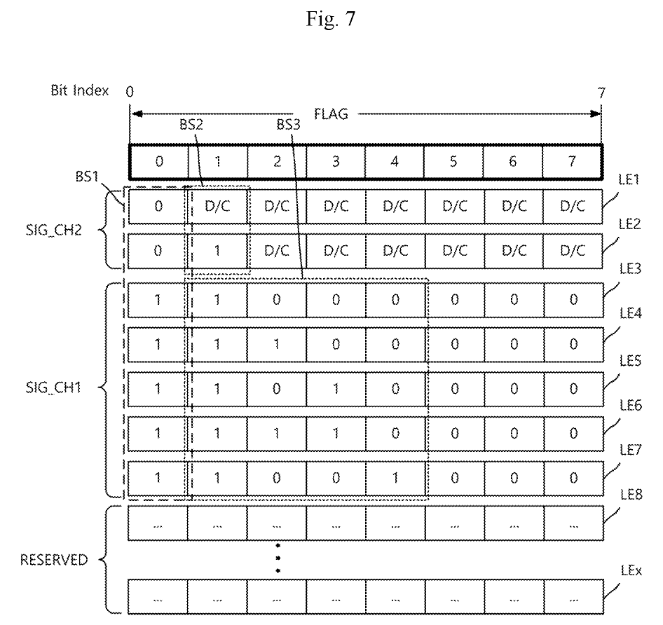

FIG. 7 is a diagram illustrating a structure of a flag signal of a log entry according to one or more embodiments. FIG. 7 illustrates a bit configuration of log entries LE1 to LEx (x may be a natural number greater than 1) encoded based on the first channel signal SIG_CH1 and the second channel signal SIG_CH2. A flag signal FLAG of FIG. 7 may correspond to the flag signal FG of FIG. 6.

The log entry encoders 135-1 and 135-2 of FIG. 5 may generate log entries LE1 to LEx based on first log information LOG_CH1, second log information LOG_CH2, and indication signal MISS. A method of encoding the flag signal FLAG by the log entry encoders 135-1 and 135-2 will be described with reference to FIG. 5 and FIG. 7.

According to one or more embodiments, the flag signal FLAG of a log entry may be used to distinguish the type of log entry and/or to distinguish an operation mode when log entries are the same type.

In one or more embodiments, the log entry encoders 135-1 and 135-2 may generate a flag signal FLAG including 8 bit signals. According to some embodiments, the flag signal FLAG may include fewer or more bit signals than 8.

In one or more embodiments, the analyzing device may distinguish whether a log entry is based on the first channel signal SIG_CH1 or the second channel signal SIG_CH2, based on the flag signal FLAG.

For example, the log entry encoders 135-1 and 135-2 may encode a bit signal, which distinguishes between the first channel signal SIG_CH1 and the second channel signal SIG_CH2, into a certain bit signal included in the flag signal FLAG.

For example, referring to FIG. 7, a first bit signal BS1 may be a bit signal that distinguishes between the first channel signal SIG_CH1 and the second channel signal SIG_CH2. The first bit signal BS1 of log entries LE1 and LE2, generated based on the second channel signal SIG_CH2, may be encoded as bit '0.' The first bit signal BS1 of log entries LE3 to LE7, generated based on the first channel signal SIG_CH1, may be encoded as bit '1.' Thus, the analyzing device may distinguish between the log entries LE3 to LE7 generated based on the first channel signal SIG_CH1 and the log entries LE1 and LE2 generated based on the second channel signal SIG_CH2, based on the first bit signal BS1 of the log entries LE1 to LE7.

In one or more embodiments, when a log entry is based on the second channel signal SIG_CH2, the analyzing device may determine whether the second channel signal SIG_CH2 is received through a first protocol or a second protocol, based on the flag signal FLAG.

For example, the log entry encoder 135-2 may encode a bit signal, which distinguishes the protocol of the second channel signal SIG_CH2, into a certain bit signal included in the flag signal FLAG.

For example, referring to FIG. 7, a second bit signal BS2 of log entries LE1 and LE2 generated based on the second channel signal SIG_CH2 may be configured based on the protocol through which the second channel signal SIG_CH2 was received.

In one or more embodiments, the second bit signal BS2 of the log entry LE1 of the second channel signal SIG_CH2 received through the first protocol is not encoded with a specific bit value (e.g., D/C), while the second bit signal BS2 of the log entry LE2 of the second channel signal SIG_CH2 received through the second protocol may be encoded with the bit '1.' Accordingly, the analyzing device may distinguish between the log entry LE1 based on the second channel signal SIG_CH2 received through the first protocol and the log entry LE2 based on the second channel signal SIG_CH2 received through the second protocol, based on the first bit signal BS1 and the second bit signal BS2 of the log entries LE1 to LEx.

In one or more embodiments, unlike the illustration of FIG. 7, the log entry LE1 of the second channel signal SIG_CH2 received through the first protocol may encode the second bit signal BS2 as bit '0,' while the second bit signal BS2 in the log entry LE2 of the second channel signal SIG_CH2 received through the second protocol may be encoded as bit '1.'

In one or more embodiments, the log entry encoder 135-1 may encode a bit signal, which distinguishes log information extracted from the first channel signal SIG_CH1, into a certain bit signal included in the flag signal FLAG.

For example, referring to FIG. 7, a third bit signal BS3 of log entries LE3 to LE7 generated based on the first channel signal SIG_CH1 may be configured based on the log information extracted from the first channel signal SIG_CH1. FIG. 7 illustrates an example in which the first log entry encoder 135-1 extracts five pieces of log information from the first channel signal SIG_CH1 and generates log entries LE3 to LE7 based on each of the five pieces of log information.

In one or more embodiments, the log entry encoders 135-1 and 135-2 may generate log entries based on log information additionally extracted from the first channel signal SIG_CH1 and the second channel signal SIG_CH2 by configuring the third to eighth bits of the flag signal FLAG.

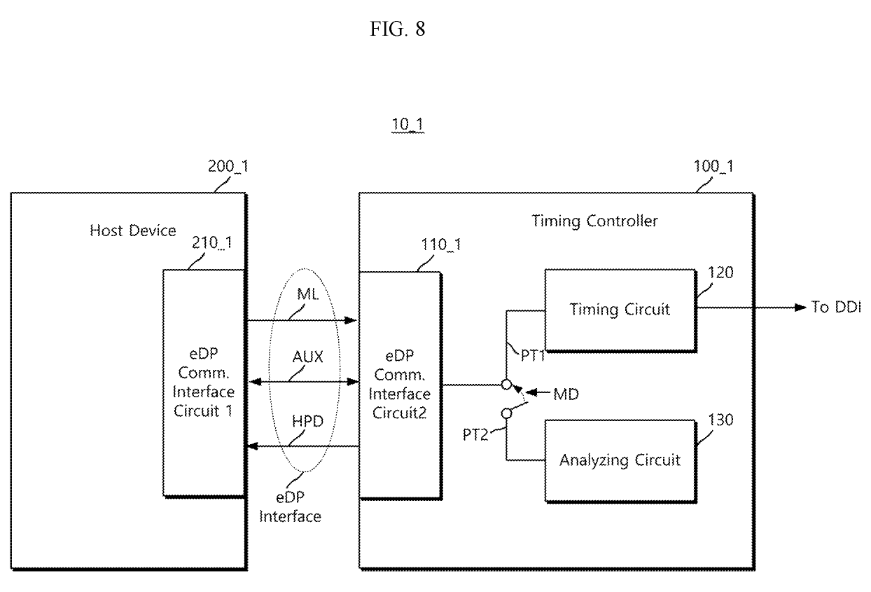

FIG. 8 is a block diagram illustrating a display system 10_1 based on an eDP interface according to one or more embodiments. The display system 10_1 based on the eDP interface will be described with reference to FIG. 8. Descriptions of overlapping or similar parts to those described above will be omitted to avoid redundancy.

Referring to FIG. 8, the display system 10_1 may include a host device 200_1 and a timing controller 100_1.

The host device 200_1 may communicate with a second eDP communication interface circuit 110_1 of the timing controller 100_1 through a first eDP communication interface circuit 210_1.

The host device 200_1 may transmit and receive display signals to and from the timing controller 100_1 through a plurality of channels ML, AUX, and HPD. The plurality of channels ML, AUX, and HPD may correspond to the first channel CH1, the second channel CH2, and the third channel CH3 of FIG. 1, respectively.

The plurality of channels ML, AUX, and HPD may correspond to a main link channel, an AUX channel, and a hot plug detect HPD channel based on the eDP protocol, respectively.

The host device 200_1 may unidirectionally transmit symbols to the timing controller 100_1 through a main link channel ML based on the eDP protocol. The host device 200_1 may transmit video data, audio data, and additional information (attribute information of the transmitted video and audio data) to the timing controller 100_1 through the main link channel ML.

The host device 200_1 and the timing controller 100_1 may bidirectionally transmit symbols through the AUX channel AUX based on the eDP protocol. The host device 200_1 and the timing controller 100_1 may exchange information necessary for link management or device management.

For example, the host device 200_1 may transmit symbols to the timing controller 100_1 through the main link channel ML and the AUX channel AUX. When the host device 200_1 detects a cable connection, the host device 200_1 may read extended display identification data (EDID) and display port configuration data (DPCD) values from the timing controller 100_1 through the AUX channel AUX and configure the main link channel ML based on the EDID and DPCD.

The first channel signal received through the main link channel ML may be received by the timing controller 100_1 at a higher speed than the second channel signal received through the AUX channel AUX. The first channel signal and the second channel signal may be asynchronous with respect to each other.

The timing controller 100_1 may unidirectionally transmit an interrupt signal (or interrupt request signal) to the host device 200_1 through the HPD channel based on the eDP protocol.

The main link channel ML may include a plurality of link lanes. The host device 200_1 may transmit a main stream signal and an additional signal to the timing controller 100_1 through the main link channel ML.

The second eDP communication interface circuit 110_1 may generate a link clock and recover a pixel clock PXLCLK, pixel data PXLDATA, an audio clock ADOCLK, and audio data ADODATA from symbols transmitted through the link lanes.

The timing controller 100_1 according to one or more embodiments may include an analyzing circuit 130 that is the same as or similar to that according to the embodiment described with reference to FIG. 1. The analyzing circuit 130 of the timing controller 100_1 may include the configuration of FIG. 5 and operate according to the method of FIG. 4.

The analyzing circuit 130 may synchronize the first channel signal received through the main link channel ML and the second channel signal received through the AUX channel AUX received from the host device 200_1. The analyzing circuit 130 may extract a portion of the synchronized first channel signal and second channel signal and store the extracted portion as log data in an internal memory device. The log data of the extracted portion may be the log entries described with reference to FIG. 6 and FIG. 7.

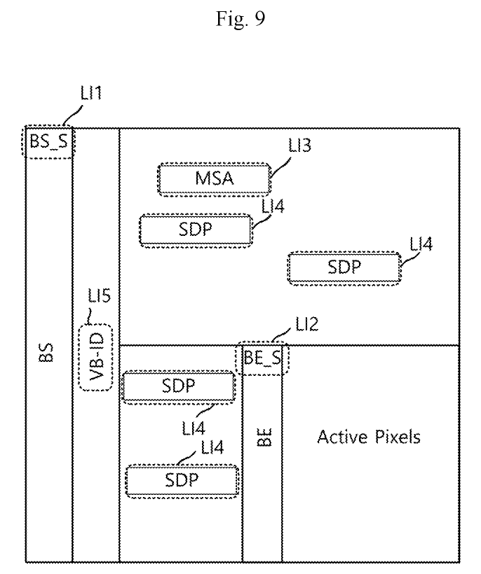

FIG. 9 is a diagram illustrating log information extracted from the first channel signal based on an eDP interface according to one or more embodiments. The first channel signal may be a signal received through the main link channel ML of FIG. 8.

FIG. 9 illustrates the first channel signal transmitted for each frame through the main link channel ML based on the eDP protocol. For example, the host device 200_1 of FIG. 8 may transmit Blanking Start (BS) and Vertical Blanking ID (VB-ID) for each line of a frame through the main link channel ML. The host device 200_1 may transmit Blanking End (BE) just before transmitting the first active pixel of a line during a vertical display period. Audio streams, or the like, may be transmitted to the timing controller 100_1 as Secondary-Data Packets (SDP). Metadata may be transmitted to the timing controller 100_1 using Main Stream Attribute (MSA) and SDP.

Certain log data according to one or more embodiments may be based on portions of BS and BE of the first channel signal transmitted through the main link channel ML of FIG. 8 for each frame.

For example, the timing controller 100_1 of FIG. 8 may extract BS Start BS_S and BE Start BE_S of each frame from the first channel signal as first log information LI1 and second log information LI2, respectively, and encode the extracted first log information LI1 and second log information LI2 into log entries.

In one or more embodiments, certain log data may be based on MSA of the first channel signal transmitted through the main link channel ML of FIG. 8 for each frame.

For example, the timing controller 100_1 of FIG. 8 may extract the MSA of the first channel signal of each frame as third log information LI3 and encode the extracted third log information LI3 into a log entry.

In one or more embodiments, certain log data may be based on a portion of the SDP of the first channel signal transmitted through the main link channel ML of FIG. 8 for each frame.

For example, the timing controller 100_1 of FIG. 8 may extract certain header bytes and certain data bytes from the SDP of the first channel signal of each frame as fourth log information LI4 and encode the extracted fourth log information LI4 into a log entry.

In one or more embodiments, the timing controller 100_1 of FIG. 8 may extract a 3-byte SDP from the SDP of the first channel signal of each frame as fourth log information LI4. For example, the timing controller 100_1 may extract a second header byte HB1 and a third header byte HB2 from the header bytes, for example, HB0 to HB3 of the SDP specified in the eDP protocol, and extract a fifth data byte DB4 from the data bytes, for example, DB0 to DB127 as the fourth log information LI4.

In one or more embodiments, a header byte and a data byte of the SDP to be extracted as log information from the first channel signal may be preconfigured in the register 134 of FIG. 5. Accordingly, the first log information extractor 133-1 of FIG. 5 may refer to the register 134 and extract the preconfigured portion from the SDP of the first channel signal of each frame as fourth log information LI4.

In one or more embodiments, certain log data may be based on VB_ID of the first channel signal transmitted through the main link channel ML of FIG. 8 for each frame.

For example, the timing controller 100_1 of FIG. 8 may extract a VB_ID value of the first channel signal of each frame as fifth log information LI5 each time the VB_ID value changes, and may encode the extracted fifth log information LI5 into a log entry.

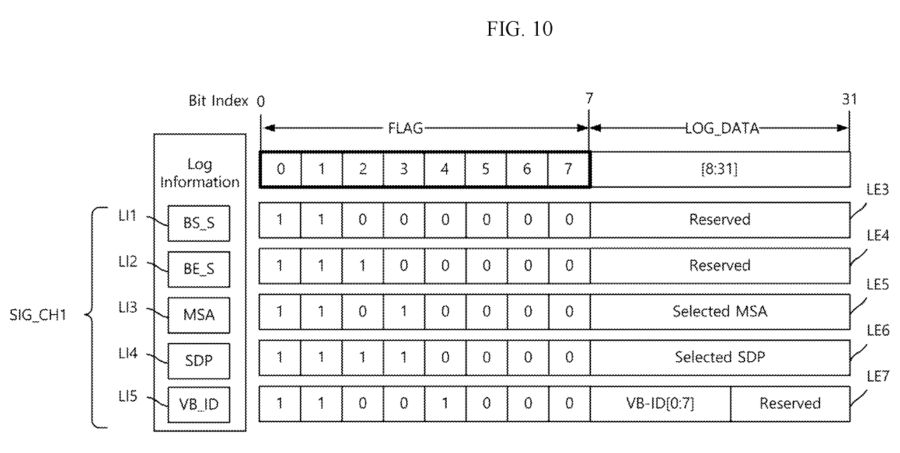

FIG. 10 is a diagram illustrating log entries based on the first channel signal SIG_CH1 according to an eDP interface according to one or more embodiments. Log entries LE3 to LE7 of FIG. 10 may correspond to the log entries LE3 to LE7 based on the first channel signal SIG_CH1 of FIG. 7.

Referring to FIG. 10, each of the log entries LE3 to LE7 may include a flag signal FLAG and a log data signal LOG_DATA. The flag signal FLAG and the log data signal LOG_DATA of each of the log entries LE3 to LE7 may correspond to the flag signal FG and the log data signal LD of FIG. 6.

The flag signal FLAG of each of the log entries LE3 to LE7 based on the first channel signal SIG_CH1 may correspond to the flag signal FLAG of each of the log entries LE3 to LE7 based on the first channel signal SIG_CH1 of FIG. 7.

For example, the flag signal FLAG of the third log entry LE3, obtained by encoding the first log information LI1 extracted from the start BS BS_S of the first channel signal SIG_CH1, may be the same as the flag signal FLAG of the third log entry LE3 of FIG. 7.

Similarly, each of the log entries LE4 to LE7, respectively obtained by encoding the second log information LI2, third log information LI3, fourth log information LI4, and fifth log information LI5, may have the same flag signal FLAG as the log entries LE4 to LE7 of FIG. 7.

In one or more embodiments, the log data signal LOG_DATA of each of the log entries LE3 to LE7 may be configured to have 24 bits. The log data signal LOG_DATA of the log entries LE3 to LE7 may be extracted from log information LI1 to LI5.

For example, the log data signal LOG_DATA of the fifth log entry LE5 may be generated from bit values stored in MSA of the first channel signal.

For example, the log data signal LOG_DATA of the sixth log entry LE6 may be generated from the bit values stored in certain bytes of the SDP of the first channel signal. For example, a second header byte HB1 and a third header byte HB2 among SDP header bytes HB0 to HB3 and a fifth data byte DB4 among data bytes DB0 to DB127 may be generated as a log data signal LOG_DATA of the sixth log entry LE6.

For example, the log data signal LOG_DATA of the seventh log entry LE7 may be generated using bit values stored in the VB-ID of the first channel signal. The VB-ID based on the eDP protocol may be a bit signal of 8 bits.

In one or more embodiments, the log data signal LOG_DATA of the first log entry LE1 and the second log entry LE2 may not be encoded. For example, the first log information LI1 based on the BS start BS_S and the second log information LI2 based on the BE start BE_S of FIG. 9 may be encoded to include only flag signals of the log entries LE3 and LE4. The analyzing device may distinguish the start of a frame and an active pixel using the log entries LE3 and LE4.

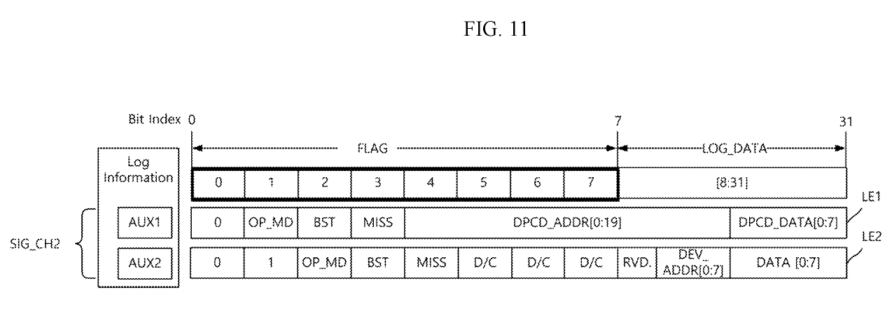

FIG. 11 is a diagram illustrating log entries LE1 and LE2 based on the second channel signal SIG_CH2 based on an eDP interface according to one or more embodiment. The log entries LE1 and LE2 of FIG. 11 may correspond to the log entries LE1 and LE2 based on the second channel signal SIG_CH2 of FIG. 7. Descriptions redundant or similar to those in FIG. 6, FIG. 7, and FIG. 10 are omitted for brevity.

Referring to FIG. 11, each of the log entries LE1 and LE2 may include a flag signal FLAG and a log data signal LOG_DATA.

The flag signal FLAG of each of the log entries LE1 and LE2 based on a second channel signal SIG_CH2 may correspond to the flag signal FLAG of each of the log entries LE1 and LE2 based on the second channel signal SIG_CH2 of FIG. 7.

In one or more embodiments, a first bit Bit Index 0 of the flag signal FLAG of the log entries LE1 and LE2 based on the second channel signal SIG_CH2 may be encoded based on the operation mode and/or protocol. For example, the first bit Bit Index 0 may be encoded as bit '0' in a native AUX mode and as bit '1' in 12C mode based on AUX (I2C over AUX mode).

A method of encoding the first log entry LE1 based on the second channel signal SIG_CH2 received through a first protocol is described. For example, the method of encoding the log entry LE1 when the second channel signal SIG_CH2 is received in the native AUX mode is described.

In one or more embodiments, a second bit Bit Index 1 of the flag signal FLAG of the first log entry LE1 may be encoded based on the operation mode. For example, the second bit Bit Index 1 of the flag signal FLAG may be encoded as bit '0' when the second channel signal SIG_CH2 is in a write mode and as bit '1' when the second channel signal SIG_CH2 is in a read mode.

In one or more embodiments, a third bit Bit Index 2 of the flag signal FLAG of the first log entry LE1 may be encoded based on burst information BST. For example, the third bit Bit Index 2 of the flag signal FLAG may be encoded as bit '1' when the second channel signal SIG_CH2 is in a burst mode and as bit '0' when the second channel signal SIG_CH2 is not in the burst mode.

In one or more embodiments, a fourth bit Bit Index 3 of the flag signal FLAG of the first log entry LE1 may be encoded based on the indication signal MISS described with reference to FIG. 5.

In one or more embodiments, the flag signal FLAG of the first log entry LE1 may be configured to have 4 bits, and the log data signal LOG_DATA may be configured to have 28 bits. The log data signal LOG_DATA of the first log entry LE1 may be encoded with a DPCD address DPCD_ADDR and DPCD data DPCD_DATA extracted from the second channel signal SIG_CH2.

The method of encoding the log entry LE2 based on the second channel signal SIG_CH2 received through a second protocol is described. For example, the method of encoding the second log entry LE2 when the second channel signal SIG_CH2 is received in I2C over AUX mode is described.

In one or more embodiments, the second bit Bit Index 1 of the flag signal FLAG of the second log entry LE2 may be set to bit '1,' and the third bit Bit Index 2 to the fifth bit Bit Index 4 may be encoded in the same manner as the second bit Bit Index 1 to the fourth bit Bit Index 3 of the flag signal FLAG of the first log entry LE1, based on the operation mode OP_MD, burst mode information BST, and indication signal MISS.

In one or more embodiments, the log data signal LOG_DATA of the second log entry LE2 may be data encoded with a device address DEV_ADDR and data DATA extracted from the second channel signal SIG_CH2.

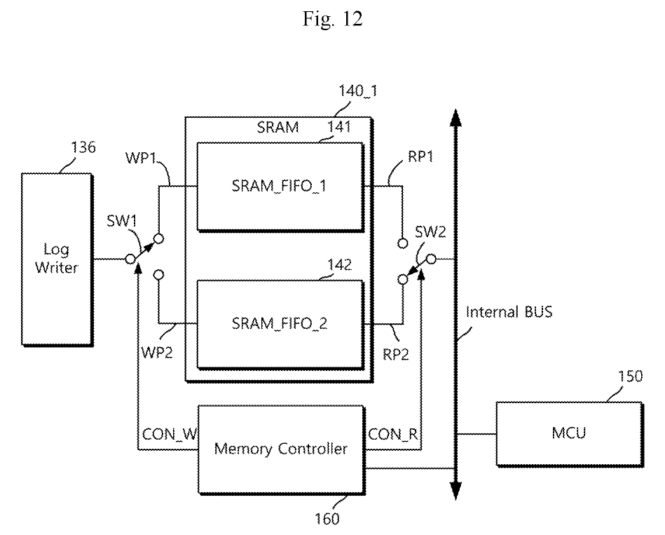

FIG. 12 is a diagram illustrating a memory device 140_1 storing log data according to one or more embodiments. The memory device 140_1 of FIG. 12 may correspond to the memory device 140 of FIG. 1. For example, the memory device 140_1 may be an SRAM.

Referring to FIG. 12, the memory device 140_1 according to one or more embodiments may include a plurality of first-in-first-out memory devices SRAM_FIFO_1 and SRAM_FIFO_2.

The memory device 140_1 may be electrically connected to a log writer 136 through a first switch SW1 and to an internal bus through a second switch SW2. An MCU 150 connected to the internal bus may be electrically connected to the memory device 140_1 through the second switch SW2.

The first switch SW1 and the second switch SW2 may be controlled by a memory controller 160. In one or more embodiments, the memory controller 160 may be implemented in hardware, and the MCU 150 may detect an interrupt request (IRQ) signal generated from the memory controller 160 and read log data stored in the memory device 140_1 using firmware.

The memory controller 160 may control the first switch SW1 by using a write control signal CON_W and dynamically control the second switch SW2 by using a read control signal CON_R.

For example, during a first time period, the memory controller 160 may activate a first write path WP1 and a second read path RP2 to store log data in the first first-in-first-out memory device SRAM_FIFO_1 and output log data from the second first-in-first-out memory device SRAM_FIFO_2 to an internal bus.

During a second time period, the memory controller 160 may activate a second write path WP2 and a first read path RP1 to store data in the second first-in-first-out memory device SRAM_FIFO_2 and output log data from the first first-in-first-out memory device SRAM_FIFO_1 to the internal bus.

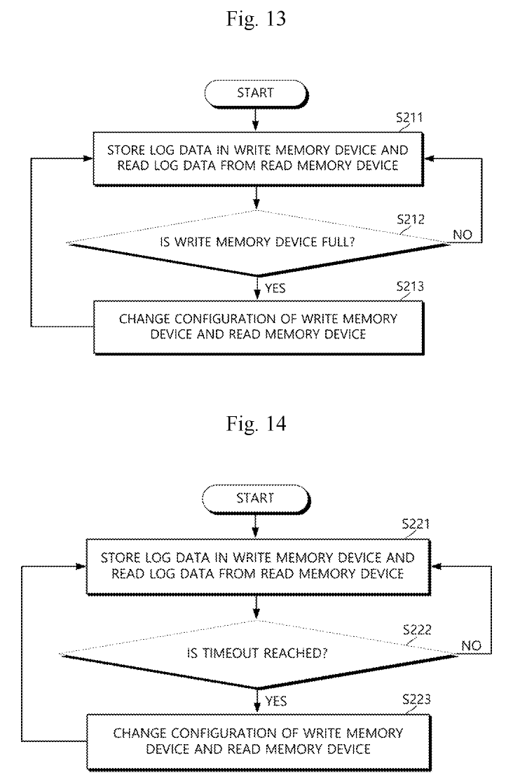

FIG. 13 to FIG. 15 are diagrams illustrating methods of operating the memory device described with reference FIG. 12. The methods of operating the memory device 140_1 will be described with reference to FIG. 12 to FIG. 15.

In one or more embodiments, the memory controller 160 of FIG. 12 may switch the roles of the first first-in-first-out memory device SRAM_FIFO_1 and the second first-in-first-out memory device SRAM_FIFO_2 when a remaining storage space of the first-in-first-out memory device storing log data reaches a predetermined threshold (for example, when there is no remaining storage space in the first-in-first-out memory device).

For example, referring to FIG. 13, in operation S211, the memory controller 160 of FIG. 12 may store log data in the first first-in-first-out memory device SRAM_FIFO_1 and output log data from the second first-in-first-out memory device SRAM_FIFO_2.

In operation S212, the memory controller 160 of FIG. 12 may determine whether the storage space of the first first-in-first-out memory device SRAM_FIFO_1 is full.

In operation S213, the memory controller 160 of FIG. 12 may control the first switch SW1 and the second switch SW2 to output log data from the first first-in-first-out memory device SRAM_FIFO_1 and store log data in the second first-in-first-out memory device SRAM_FIFO_2.

In one or more embodiments, the memory controller 160 of FIG. 12 may switch the roles of the first first-in-first-out memory device SRAM_FIFO_1 and the second first-in-first-out memory device SRAM_FIFO_2 when reaching a predetermined timeout. For example, when a predetermined time is set as timeout information and elapses, the memory controller 160 may switch the roles of the first first-in-first-out memory device SRAM_FIFO_1 and the second first-in-first-out memory device SRAM_FIFO_2.

For example, referring to FIG. 14, operations S221 and S223 may be the same as operations S211 and S213 of FIG. 13, respectively.

In operation S222, the memory controller 160 of FIG. 12 may determine whether the time set as the timeout has been reached.

In one or more embodiments, the memory controller 160 of FIG. 12 may switch the roles of the first first-in-first-out memory device SRAM_FIFO_1 and the second first-in-first-out memory device SRAM_FIFO_2 when receiving an interrupt signal. For example, the memory controller 160 may switch the roles of the first first-in-first-out memory device SRAM_FIFO_1 and the second first-in-first-out memory device SRAM_FIFO_2 when receiving an interrupt signal from the MCU 150.

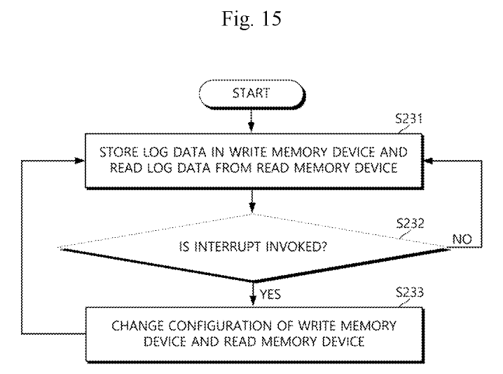

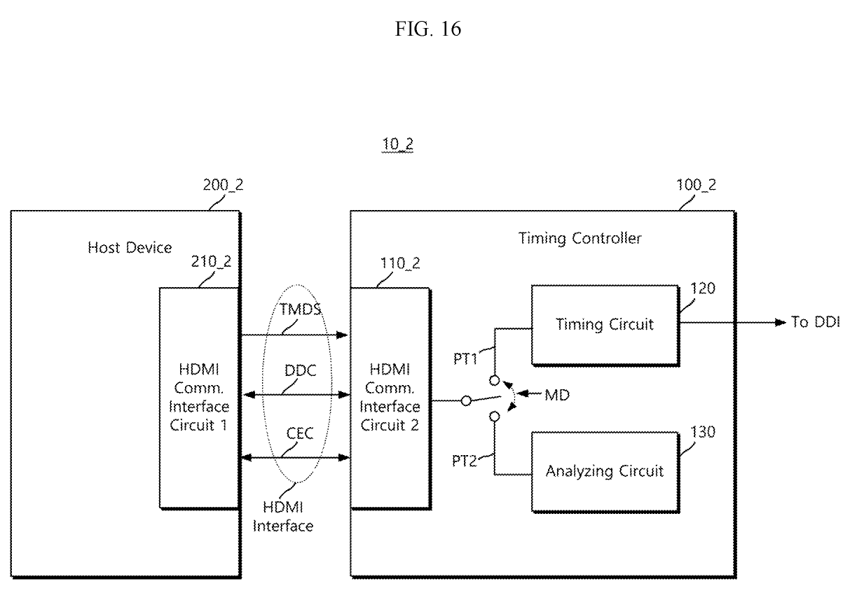

For example, referring to FIG. 15, operations S231 and S233 may be the same as operations S211 and S213 of FIG. 13, respectively.

In operation S232, the memory controller 160 of FIG. 12 may determine whether it has received the interrupt signal.

FIG. 16 is a block diagram illustrating a display system 10_2 based on an HDMI interface according to one or more embodiments. The display system 10_2 based on the HDMI interface will be described with reference to FIG. 16. Descriptions of parts that are redundant or similar to the embodiments described with reference to FIG. 1 to FIG. 7 will be omitted for brevity.

A host device 200_2 may communicate with a second HDMI communication interface circuit 110_2 of a timing controller 100_2 through a first HDMI communication interface circuit 210_2.

The host device 200_2 may transmit and receive display signals to and from the timing controller 100_2 through a plurality of channels TMDS, DDC, and CEC. The plurality of channels TMDS, DDC, and CEC may correspond to the first channel CH1, the second channel CH2, and the third channel CH3 of FIG. 1, respectively.

The plurality of channels TMDS, DDC, and CEC may correspond to a transition minimized differential signaling (TMDS) channel, a display data channel (DDC), and a consumer electronics control (CEC) channel based on an HDMI protocol.

In one or more embodiments, a first channel signal received through the first channel TMDS and a second channel signal received through the second channel DDC may be synchronized with each other. Log data including log entries based on FIG. 6 and FIG. 7 may be stored in an internal memory device based on the first channel signal and the second channel signal.

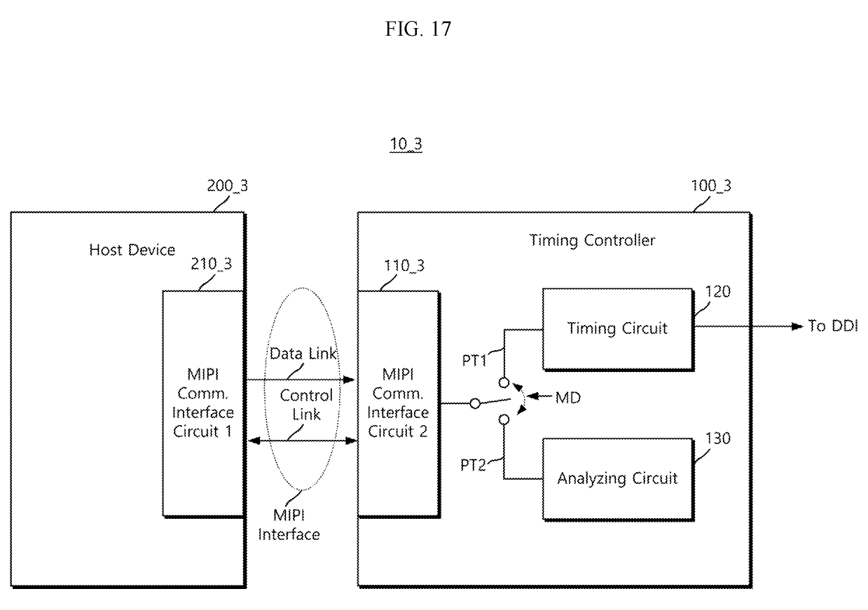

FIG. 17 is a block diagram illustrating a display system 10_3 based on a MIPI interface according to one or more embodiments. The display system 10_3 based on the MIPI interface will be described with reference to FIG. 17. Descriptions of parts that are redundant or similar to the embodiments described with reference to FIG. 1 to FIG. 7 will be omitted for brevity.

A host device 200_3 may communicate with a second MIPI communication interface circuit 110_3 of a timing controller 100_3 through a first MIPI communication interface circuit 210_3.

The host device 200_3 may transmit and receive display signals to and from the timing controller 100_3 through a plurality of channels Data Link and Control Link. The plurality of channels Data Link and Control Link may correspond to the first channel CH1 and the second channel CH2 of FIG. 1, respectively.

The plurality of channels Data Link and Control Link may correspond to Data Link and Control Link based on a MIPI protocol, respectively.

In one or more embodiments, a first channel signal received through the first channel Data Link and a second channel signal received through the second channel Control Link may be synchronized with each other. Log data including the log entries based on FIG. 6 and FIG. 7 may be stored in an internal memory device based on the first channel signal and the second channel signal.

For brevity of description, the embodiments based on the eDP interface and the MIPI interface have been described, but example embodiments may be applied to a display system including other display interfaces. For example, channel signals transmitted through a plurality of channels of a display interface having different transmission speeds may be synchronized with each other. Information extracted from the synchronized channel signals may be stored as log data in an internal memory device. When sampling timings of the synchronized channel signals are the same, one channel signal may be stored in the internal memory device, and then the other channel signal may be encoded with insertion of an indication signal.

As set forth above, according to one or more embodiments, a display scenario of a host may be stably analyzed.

According to one or more embodiments, a display scenario of a host may be stably analyzed even when the host transmits signals through a plurality of asynchronous channels.

According to one or more embodiments, a display scenario of a host may be stably analyzed in an actual operating environment of a display device.

While various embodiments have been shown and described above, it will be apparent to those skilled in the art that modifications and variations could be made without departing from the scope of the present invention as defined by the appended claims.

What is claimed is:

1. A timing controller comprising:
a communication interface circuit configured to receive a first channel signal and a second channel signal from a host device through a first channel and a second channel, respectively;
a timing circuit configured to generate display data based on the first channel signal and the second channel signal, and transmit the display data to a source driver; and
an analyzing circuit configured to synchronize the first channel signal and the second channel signal, extract a portion of the synchronized first channel signal and second channel signal, and store the extracted portion as log data in an internal memory device.

2. The timing controller of claim 1, further comprising:
a first internal signal path connecting the communication interface circuit to the timing circuit;
a second internal signal path connecting the communication interface circuit to the analyzing circuit; and
a selection circuit configured to selectively activate either the first internal signal path or the second internal signal path based on a mode signal.

3. The timing controller of claim 1, wherein the first channel signal and the second channel signal are asynchronous with respect to each other.

4. The timing controller of claim 3, wherein the analyzing circuit comprises a synchronizer configured to synchronize the first channel signal and the second channel signal.

5. The timing controller of claim 4, wherein:
the communication interface circuit is configured to output the first channel signal based on a first clock signal and output the second channel signal based on a second clock signal, and
a clock frequency of the first clock signal is different from a clock frequency of the second clock signal.

6. The timing controller of claim 1, wherein:
the analyzing circuit is configured to store the log data as at least one log entry in the internal memory device, and
each of the at least one log entry comprises a flag signal and a log data signal.

7. The timing controller of claim 6, wherein the analyzing circuit is configured to generate the log data signal by extracting a portion of the first channel signal and the second channel signal.

8. The timing controller of claim 6, wherein the analyzing circuit is configured to generate the flag signal by encoding a first bit signal that distinguishes between the first channel signal and the second channel signal.

9. The timing controller of claim 6, wherein the analyzing circuit is configured to store a second bit signal that distinguishes between the second channel signal received through a first protocol and the second channel signal received through a second protocol, in the flag signal.

10. The timing controller of claim 6, wherein the analyzing circuit comprises:
a synchronizer configured to synchronize the first channel signal based on a first clock signal and the second channel signal based on a second clock signal having a clock frequency different from a clock frequency of the first clock signal; and
a priority checker configured to compare sampling timings of the synchronized first channel signal and second channel signal.

11. The timing controller of claim 10, wherein the analyzing circuit is configured to prioritize and store a log entry based on the first channel signal in the internal memory device when the sampling timings of the synchronized first channel signal and second channel signal are the same.

12. The timing controller of claim 11, wherein the analyzing circuit is configured to store a third bit signal in the flag signal of a log entry based on the second channel signal when the sampling timings of the synchronized first channel signal and second channel signal are the same.

13. The timing controller of claim 6, wherein:
the first channel signal is a signal of a main link based on an embedded DisplayPort (eDP), and the second channel signal is a signal of an auxiliary channel (AUX) based on an eDP, and
the analyzing circuit is configured to extract a portion of a secondary-data packet (SDP) from the first channel signal to generate the log data signal.

14. The timing controller of claim 13, wherein:
the SDP comprises a total of four header bytes from a first header byte to a fourth header byte, and a total of 128 data bytes from a first data byte to a 128th data byte, and
the analyzing circuit is configured to extract a second header byte, a third header byte, and a fifth data byte from the SDP of the first channel signal to generate the log data signal.

15. The timing controller of claim 13, wherein:
the SDP comprises a total of four header bytes from a first header byte to a fourth header byte, and a total of 128 data bytes from a first data byte to a 128th data byte, and
the analyzing circuit is configured to extract at least a portion of the SDP from the first channel signal with reference to a register and generate the log data signal based on the extracted portion of the SDP.

16. The timing controller of claim 1, wherein:
the internal memory device comprises a plurality of first-in-first-out (FIFO) memory devices, and
the timing controller further comprises a memory controller configured to dynamically configure the plurality of FIFO memory devices as a first FIFO memory device configured to store the log data and a second FIFO memory device configured to output the log data.

17. The timing controller of claim 16, wherein the memory controller is configured to switch configurations between the first FIFO memory device and the second FIFO memory device based on one of timeout information, an external interrupt, and a remaining storage space of the first FIFO memory device.

18. A display device comprising:
a timing controller configured to receive a first channel signal and a second channel signal from a host device through a first channel and a second channel, respectively, generate display data based on the first channel signal and the second channel signal, and transmit the display data to a display driving integrated circuit; and
the display driving integrated circuit configured to drive a display panel based on the display data,
wherein the timing controller comprises:
an analyzing circuit configured to synchronize the first channel signal and the second channel signal, extract a portion of the synchronized first channel signal and second channel signal, and store the extracted portion as log data in an internal memory device.

19. The display device of claim 18, wherein the timing controller further comprises:
a communication interface circuit configured to receive the first channel signal and the second channel signal from the host device through the first channel and the second channel, respectively;
a timing circuit configured to generate display data based on the first channel signal and the second channel signal, and transmit the display data to a source driver;
a first internal signal path connecting the communication interface circuit to the timing circuit;
a second internal signal path connecting the communication interface circuit to the analyzing circuit; and
a selection circuit configured to selectively activate either the first internal signal path or the second internal signal path based on a mode signal.

20. A method of operating a timing controller, the method comprising:
receiving a first channel signal and a second channel signal from a host device;
synchronizing the first channel signal and the second channel signal;
comparing sampling timings of the first channel signal and the second channel signal;
extracting first log information and second log information from the synchronized first channel signal and second channel signal, respectively;
generating a first log entry and a second log entry by encoding the first log information and the second log information; and
storing the first log entry and the second log entry in an internal memory device.
